(19) United States
(12) Patent Application Publication
(10) Pub. No.: US 2015/0229157 A1
(43) Pub. Date: Aug. 13, 2015

(54) ON-VEHICLE WIRELESS CHARGER

(71) Applicant: HON HAI PRECISION INDUSTRY CO., LTD., New Taipei (TW)

(72) Inventors: SHIANG-HUA LIN, New Taipei (TW); PING-MAO LEE, New Taipei (TW); KUANG-YAO LIAO, New Taipei (TW); CHIH-CHUNG WENG, New Taipei (TW)

(21) Appl. No.: 14/587,288

(22) Filed: Dec. 31, 2014

(30) Foreign Application Priority Data
Feb. 11, 2014 (TW) 103104342

(51) Int. Cl. H02J 7/02; H02J 7/00

(52) U.S. Cl. CPC H02J 7/025; H02J 7/0027; H02J 7/0042

(57) ABSTRACT

An on-vehicle wireless charger mounted on top of a dashboard of vehicle includes a vehicle power source supply cable, a fixed member, a sunlight resisting pad, and a transmitting module. The fixed member is attached to the dashboard. The sunlight resisting pad is attached to the fixed member. The transmitting module is electrically mounted on the fixed member and connected to the vehicle power source supply cable. The transmitting module is sandwiched between the sunlight resisting pad and the fixed member.

### FIELD

The subject matter herein generally relates to a charger, and more particularly, to an on-vehicle wireless charger.

### BACKGROUND

Portable electronic devices such as mobile phones, laptop computers, and the like have various functions, and are commonly used in the automobile electronic market. A battery is typically used for portability in such portable electronic devices. Battery charging methods can be classified into wired charging and wireless charging. The wireless charging method can be classified into an electromagnetic induction type using an electromagnetic induction phenomenon and a magnetic resonance type for transmitting power at the same frequency to both transmitting and receiving ends. Among the wireless charging methods, the electromagnetic induction type charges a battery by applying power to a charging pad including a coil therein and using an induced current generated in a coil included in the battery of the portable electronic device due to an electromagnetic field generated from the coil located inside the charging pad.

### BRIEF DESCRIPTION OF THE DRAWINGS

Implementations of the present technology will now be described, by way of example only, with reference to the attached figures.

FIG. 1 is an isometric view of one embodiment of an on-vehicle wireless charger.

FIG. 2 is an exploded isometric view of the on-vehicle wireless charger in FIG. 1.

FIG. 3 is a side perspective view of the on-vehicle wireless charger in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” when utilized, means “including, but not necessarily limited to”; it specifically indicates open-ended inclusion or membership in the so-described combination, group, series and the like.

The present disclosure is described in relation to a wireless charger mounted on a vehicle.

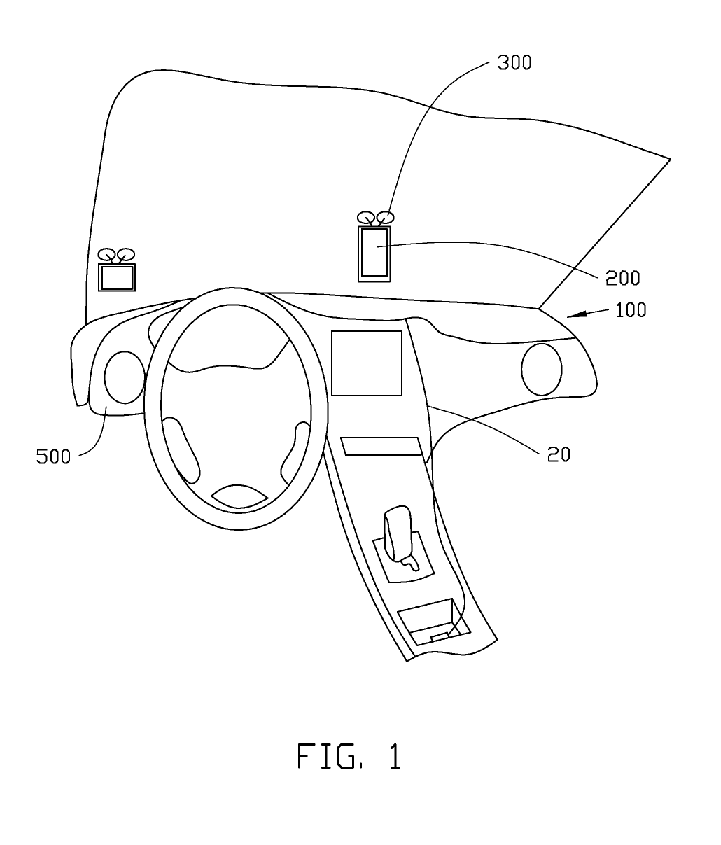

FIG. 1 illustrates that an on-vehicle wireless charger 100 can be mounted on top of a dashboard 500 of vehicle and configured to charge an electronic device 200. The electronic device 200 can be fixed on a windshield (not labeled) of the vehicle by a kickstand 300. The on-vehicle wireless charger 100 can include a vehicle power supply cable 20.

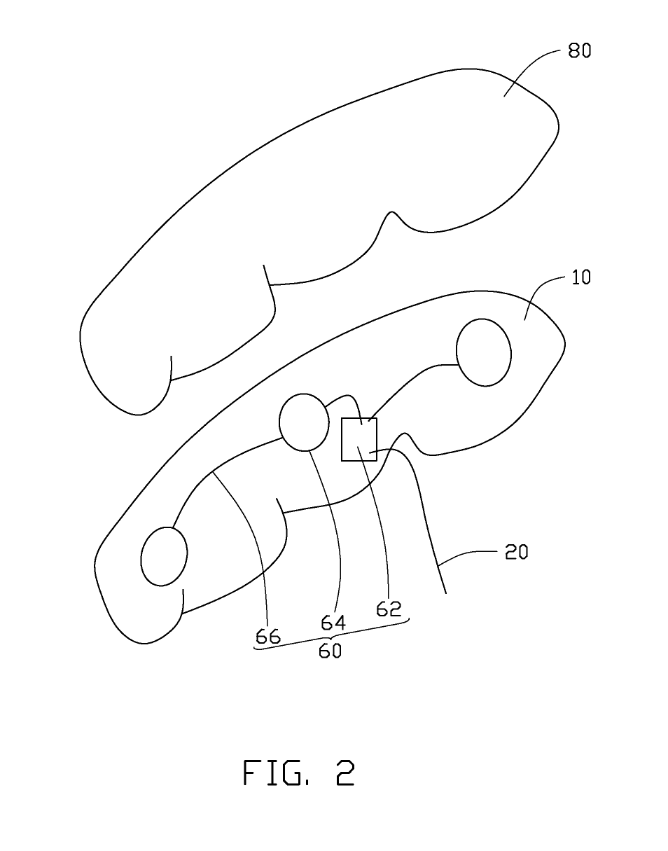

FIG. 2 illustrates that the on-vehicle wireless charger 100 can further include a fixed member 10, a transmitting module 60, and a sunlight resisting pad 80. The fixed member 10 can be mounted on the dashboard 500 near the windshield, and configured to fix the transmitting module 60. One end of the vehicle power supply cable 20 can be connected to a vehicle power supply (not shown), and the other end of the vehicle power supply cable 20 can pass through the fixed member 10 and electrically connected to the transmitting module 60. The transmitting module 60 can be mounted on the fixed member 10 and capable of transmitting electromagnetic wave to the electronic device 200. The sunlight resisting pad 80 can cover the transmitting module 60, thereby the transmitting module 60 can be insulated.

The fixed member 10 can be a thin sheet. In at least one embodiment, the fixed member 10 can be made of an anti-slippery material. The transmitting module 60 can be mounted on fixed member 10, and can include a wireless charging module 62, a plurality of transmitting coils 64, and a connecting wire 66 electrically connected to the wireless charging module 62 and the transmitting coils 64. The wireless charging module 62, the transmitting coil 64, and the connecting wire 66 can be mounted on the fixed member 10 by adhering or clasping. In at least one embodiment, the wireless charging module 62 can be positioned at the central portion of the fixed member 10 and connected to the vehicle power supply by the vehicle power supply cable 20. The transmitting coils 64 can be positioned on the fixed member 10 and distanced form each other. In at least one embodiment, there are three transmitting coils 64. Two transmitting coils 64 can be positioned at one side of the wireless charging module 62, and one transmitting coils 64 can be positioned at the other side of the wireless charging module 62. The connecting wire 66 can be positioned on the fixed member 10, and electrically connected between the wireless charging module 62 and the transmitting coil 64. The two transmitting coils 64 positioned at one side of the wireless charging module 62 can be electrically connected by the connecting wire 66, and one of the two transmitting coils 64 can be electrically connected to the wireless charging module 62 by the connecting wire 66. The other transmitting coils 64 on the other side of the wireless charging module 62 can be electrically connected to the wireless charging module 62 by the connecting wire 66. The sunlight resisting pad 80 can be mounted on the fixed member 10 and closely cover the transmitting module 60. A side and a shape of the sunlight resisting pad 80 can be substantially the same as the fixed member 10.

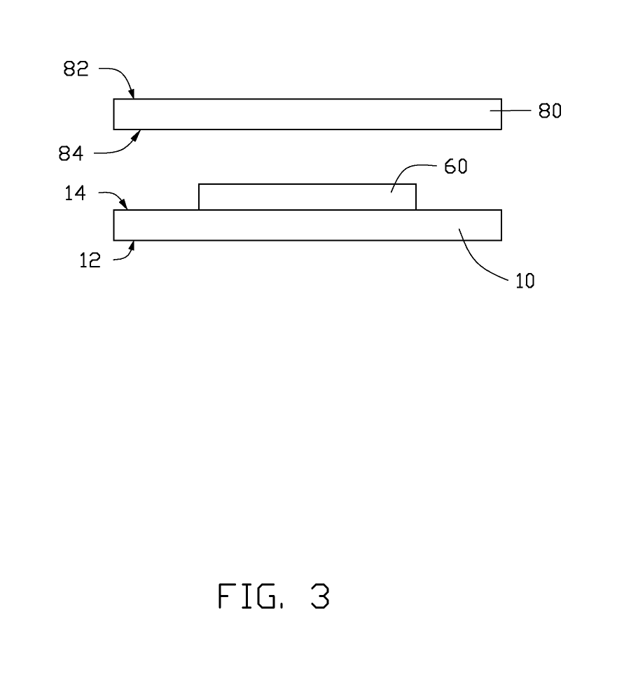

FIG. 3 illustrates that the fixed member 10 includes an anti-slippery surface 12 and a supporting surface 14 opposite the anti-slippery surface 12. The anti-slippery surface 12 can be attached to the dashboard 500 (as shown in FIG. 1), and can be composed of an anti-slippery material layer. The fixed member 10 can be closely attached to the dashboard 500 to prevent if from falling off the dashboard 500, and the electronic device 200 can be charged stably during moving of the vehicle. The anti-slippery material layer can be made of a polyvinyl chloride (PVC), a silica gel, or a polyurethane (PU). The transmitting module 60 can be mounted on the supporting surface 14.

The sunlight resisting pad 80 can include a sunlight resisting surface 82 and an attached surface 84 opposite the sunlight resisting surface 82. The sunlight resisting surface 82 can include a flannelette layer, a non-textile layer, and an active carbon layer. The sunlight resisting surface 82 can cut reflections of light outside of the vehicle, and lower the temperature in the vehicle. The attached surface 84 can be fixed on the supporting surface 14 and cover above the transmitting module 60, so the transmitting module 60 can be sandwiched between the fixed member 10 and the sunlight resisting pad 80.

In assembly, the fixed member 10 can be mounted on the dashboard 500, and the transmitting module 60 can be mounted on the fixed member 10. Then, the sunlight resisting pad 80 can be attached to the fixed member 10 to cover the transmitting module 60. The transmitting module 60 and the vehicle power supply can be electrically connected by the vehicle power supply cable 20.

In use, the on-vehicle wireless charger 100 can be positioned on the dashboard 500, and the electronic device 200 can be positioned on the windshield of the vehicle by the kickstand 300. Therefore, user can watch a display panel of the electronic device 200 when the electronic device 200 is charging.

The on-vehicle wireless charging 100 can include the sunlight resisting pad 80, and the transmitting module 60 can be mounted under the sunlight resisting pad 80. The sunlight resisting pad 80 can reduce reflections of the light outside of the vehicle and lower the temperature in the vehicle, so it is safe to use, and the transmitting module 60 can be insulated. As the transmitting coils 64 can be shielded by the sunlight resisting pad 80, it can be enlarged and the number of it can be increased. Therefore, two or more electronic devices 200 can be charged at the same time. The fixed member 10 can be positioned under the transmitting module 60, and the fixed member 10 can be the anti-slippery mat, so the transmitting module 60 would not slide when the vehicle moves, and the electronic device 200 can be charged stably.

In other embodiments, the wireless charging module 62, the transmitting coil 64, and the connecting wire 66 can be coated on the supporting surface 14. The number of the transmitting coils 64 can be one, two, or more than three. The plurality of the transmitting coils 64 can be positioned around the wireless charging module 62 and electrically connected to the wireless charging module 62. The plurality of the transmitting coils 64 can be evenly distanced from each other.

The embodiments shown and described above are only examples. Many details are often found in the art such as the other features of an on-vehicle wireless charger. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An on-vehicle wireless charger, comprising:
a vehicle power source supply cable;
a fixed member mounted on a dashboard;
a sunlight resisting pad attached to the fixed member; and
a transmitting module electrically mounted on the fixed member and connected to the vehicle power source supply cable, the transmitting module being sandwiched between the sunlight resisting pad and the fixed member.

2. The on-vehicle wireless charger as claimed in claim 1, wherein the fixed member is an anti-slippery mat; and the fixed member comprises an anti-slippery surface attached to the dashboard and a supporting surface opposite the anti-slippery surface.

3. The on-vehicle wireless charger as claimed in claim 2, wherein:
the anti-slippery surface comprises an anti-slippery layer, and the fixed member is firmly attached to the dashboard; and
the transmitting module is mounted on the supporting surface.

4. The on-vehicle wireless charger as claimed in claim 3, wherein the anti-slippery layer is made of a polyvinyl chloride, a silica gel, or a polyurethane.

5. The on-vehicle wireless charger as claimed in claim 3, wherein the transmitting module is coated on the supporting surface.

6. The on-vehicle wireless charger as claimed in claim 3, wherein:
the transmitting module comprises a wireless charging module and a plurality of transmitting coils;
the wireless charging module is electrically connected to the vehicle power supply cable and the plurality of the transmitting coils; and
the wireless charging module is positioned at a central portion of the supporting surface, and the plurality of the transmitting coils are distanced from each other on the supporting surface.

7. The on-vehicle wireless charger as claimed in claim 6, wherein:
the transmitting coils are three;
two transmitting coils are electrically connected with each other and positioned at one side of the wireless charging coil, and one of the two transmitting coils is electrically connected to the charging module; and
the other transmitting coil is positioned at the other side of the wireless charging module and electrically connected to the wireless charging module.

8. The on-vehicle wireless charger as claimed in claim 6, wherein the plurality of the transmitting coils are positioned around the wireless charging module and distanced from each other; and each of the plurality of the transmitting coils is electrically connected to the wireless charging module.

9. The on-vehicle wireless charger as claimed in claim 2,
wherein a size and a shape of the sunlight resisting pad are substantially the same with the fixed member;
wherein the sunlight resisting pad comprises a sunlight resisting surface and an attached surface, and the attached surface is fixed on the fixed member and covers with the transmitting module.
